(19) United States
(12) Patent Application Publication
(10) Pub. No.: US 2006/0277301 A1
(43) Pub. Date: Dec. 7, 2006

(54) File protection for a network client

(76) Inventors: Hitoshi Takanashi, Fremont, CA (US); Yi Sun, San Jose, CA (US)

Correspondence Address: TROP PRUNER & HU, PC, 1616 S. VOSS ROAD, SUITE 750, HOUSTON, TX, 77057-2631, US

(21) Appl. No.: 11/145,833

(22) Filed: Jun. 6, 2005

(51) Int. Cl. G06F 15/173

(52) U.S. Cl. 709/225

(57) ABSTRACT

A technique includes selectively preventing decryption of a file by a client based on whether a network connection exists between the client and a server.

### BACKGROUND

The invention generally relates to file protection for a network client.

A typical network may include a server and multiple clients. The clients typically include portable devices, such as laptop computers and personal digital assistants (PDAs), which may be easily removed from the network. Due to their portability, these clients typically are susceptible to being stolen.

A portable network client may contain sensitive files. Because a hacker has full access to the client's hard disk when in possession of the client, protecting sensitive files that are stored on the hard disk from being accessed is typically more challenging when the client has been stolen. A security device, such as a hardware lock or a biometric sensor-based lock, may be used to protect the entire hard disk of the client. However, usually such a security device provides either all or no access to every bit on the disk; and thus, the security device does not protect only a select number of sensitive files that are stored on the client.

Thus, there exists a continuing need for a technique and/or system to prevent unauthorized access to files that are stored on a network client.

### BRIEF DESCRIPTION OF THE DRAWING

FIG. 1 is a block diagram of a network according to an embodiment of the invention.

FIG. 2 is a flow diagram depicting a technique to protect sensitive files that are stored on a client of the network according to an embodiment of the invention.

FIG. 3 is a flow diagram depicting a technique performed by the client to prevent unauthorized file access according to an embodiment of the invention.

FIG. 4 is a flow diagram depicting a technique performed by the client in response to a network connection being formed according to an embodiment of the invention.

FIG. 5 is a flow diagram depicting a technique used by the client to store a file according to an embodiment of the invention.

FIG. 6 is a flow diagram depicting a technique used by the client to retrieve a file according to an embodiment of the invention.

FIG. 7 is a signal flow diagram depicting security features to prevent unauthorized access to sensitive files according to an embodiment of the invention.

FIG. 8 is a block diagram depicting a software architecture of the client according to an embodiment of the invention.

FIG. 9 is a schematic diagram of a hardware architecture of the client according to an embodiment of the invention.

FIG. 10 is a schematic diagram of a wireless device according to an embodiment of the invention.

FIG. 11 is a flow diagram depicting a security technique based on the number of log-in attempts within a predetermined window of time.

FIG. 12 is a flow diagram depicting a security technique involving communication between a server and a client.

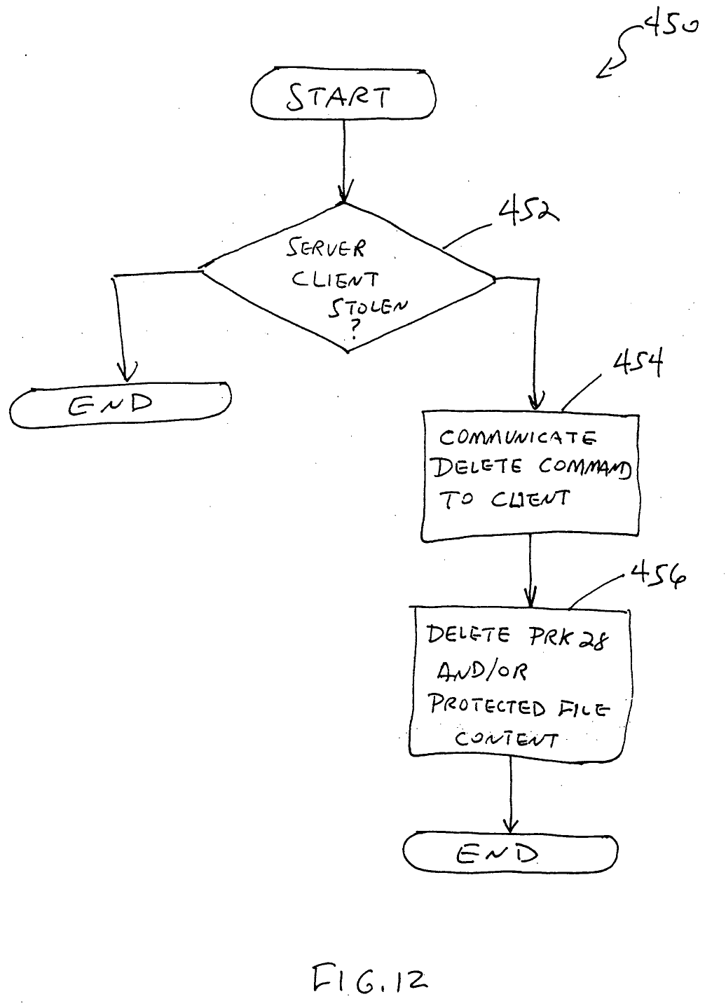

### DETAILED DESCRIPTION

In accordance with some embodiments of the invention described herein, portable network clients use an asymmetric cryptographic security system for purposes of preventing unauthorized access to sensitive files. Pursuant to the asymmetric cryptographic security system, each client possesses a key pair when connected to the network: 1.) a private key that is kept secretly; and 2.) a matching public key that may be published in the public domain. As compared to a symmetric cryptographic security system, the asymmetric cryptographic security system permits entities that have no preexisting security arrangement to exchange messages securely. However, the asymmetric cryptographic security system typically has not been used in the past to directly encrypt or decrypt files, such as files that are stored on a mobile client, because of the performance impact on the client.

Some existing ways to apply asymmetric cryptographic techniques to file protection stores both a private key and a public key of each user on the client computer. Although these keys are protected by a user identification (ID), password and/or other credentials, it is still possible to be compromised while an attacker has full access to the client (such as when the client is stolen, for example). Although clients may be generally protected when they are connected to an enterprise network system, there are more risks for access to sensitive files when the client has been removed from the system.

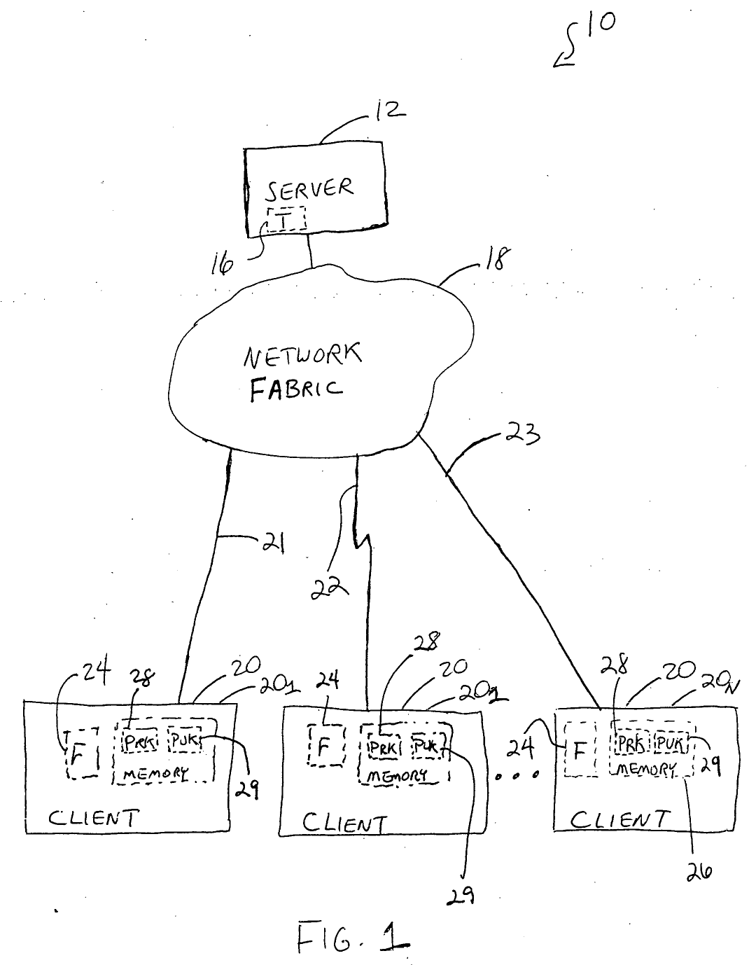

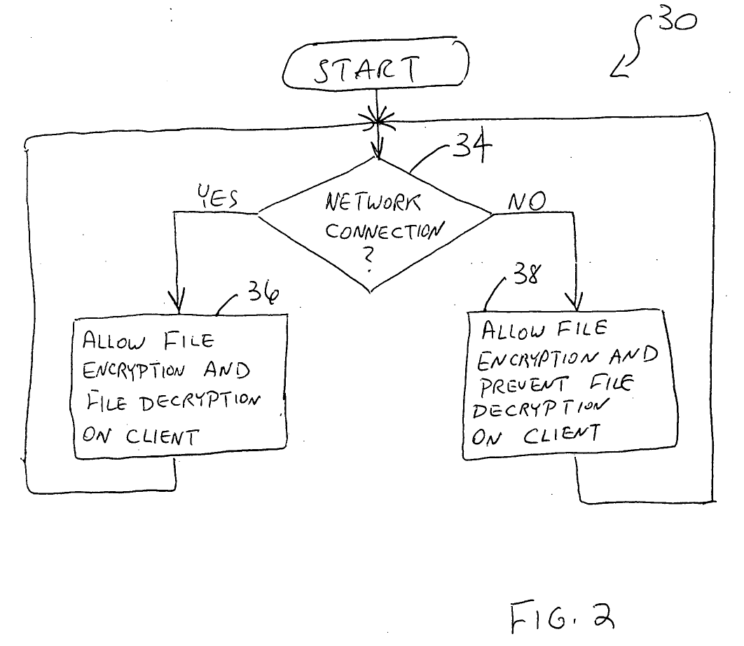

Referring to FIG. 1, in accordance with an embodiment of the invention, a network 10 includes a server 12 and multiple clients (N clients 20₁, 20₂ . . . 20_{N}, depicted as examples) that communicate over network fabric 18. As described below, the clients 20 and the server 12 implement an asymmetric cryptographic security system that, for each client 20, is based on whether the particular client 20 has a network connection. More specifically, the file access decryption abilities of each client 20 are removed when the client 20 loses its network connection. Thus, referring also to FIG. 2 in conjunction with FIG. 1, in accordance with a technique 30, if a particular client 20 determines (diamond 34) that its network connection has been lost, then the client 20 permits file encryption on the client 20 but prevents file decryption on the client 20, as depicted in block 38. As long as the network connection is present, however, the client 20 allows both file encryption and file decryption on the client 20, as depicted in block 36. Therefore, after a client 20 loses its network connection, sensitive files that are stored on the client 20 may not be retrieved.

In the context of this application, a network connection is considered lost when either 1.) the client 20 has logged off of the network 10; or 2.) the ability of the client 20 to communicate with the network 10 has been disrupted. For example, the client 20 may be disconnected from its network cable or may be carried outside of the wireless range needed to establish a network connection with the network 10.

Referring back to FIG. 1, in accordance with some embodiments of the invention, the above-described control of the client's ability to decrypt files is controlled through regulating the client's access to one of a pair of asymmetric keys that are stored in a table 16 of the server 12. In accordance with some embodiments of the invention, each pair may be associated with one of the clients 20. For example, the server 12 may store a unique pair of asymmetric keys (in some embodiments of the invention) in the table 16 for each client 20 so that when the client 20 establishes a network connection, the server 12 communicates with the client 20 to ensure the corresponding asymmetric pair of keys are stored on the client 20.

As a more specific example, FIG. 1 depicts exemplary clients 20, each of which for this example are currently connected to the network 10. Each client 20 includes a memory 26 (a system memory, for example) that stores a private key (PRK) 28 and a public key (PUK) 29, a pair of asymmetric keys that were originally obtained from the server 12. The PRKs 28 and 29 may each be deterministic and non-predictable, in some embodiments of the invention. Each client 20 may store sensitive files 24 (herein called “protected files 24”) that are to be protected from unauthorized access by the asymmetric cryptographic security system that is disclosed herein.

The PRK 28 and PUK 29 are used by the client 20 (as described below) for purposes accessing the files 24. As a more specific example, it is assumed below that the client 20 uses the PRK 28 for purposes of decrypting its protected files 24 and uses the PUK 29 for purposes of encrypting its protected files 24. It is noted that this assumption is for purposes of simplifying the following description. It is understood, however, that in other embodiments of the invention, the roles of the PRK 28 and PUK 29 may be reversed: the client 20 may use the PUK 29 for purposes of decrypting protected files 24 and use the PRK 28 for purposes of encrypting protected files 24. Thus, other embodiments of the invention are possible and are within the scope of the appended claims.

In accordance with at least some of the embodiments of the invention, the client 20 controls its own access to its local copy of the PRK 28 for purposes of preventing unauthorized decryption of protected files 24. More specifically, in accordance with some embodiments of the invention, in response to the client 20 detecting loss of its network connection, the client 20 prevents itself from accessing the PRK 28. In this regard, depending on the particular embodiment of the invention, the client 20 may erase the locally stored PRK 28, remove a handle pointing the locally stored PRK 28, or use another technique to prevent client access to the PRK 28 in response to the removal, or loss, of the client's network connection. Because the client 20 can no longer access the PRK 28 in the event of the loss of a network connection, none of the protected files 24 may be accessed. Therefore, even under the less-controlled environment that occurs when the client 20 is removed from the network 10, cryptographic security measures are used to inhibit access to the protected files 24.

To summarize, the pair of asymmetric keys for a particular client 20 may be managed in the following manner, in some embodiments of the invention. When the client 20 first logs onto the network 10, the server 12, by accessing the associated entry in its table 16, locates the pair of asymmetric keys for the client 20. If this is the first time the client 20 has logged onto the network 10, the server 12 communicates both the PRK 28 and the PUK 29 to the client 20. However, if the client 20 is re-logging onto the network 10, then the client 20 already has the PUK 29. The client 20, however, does not possess the PRK 28 due to the removal of the PRK 28 by the client 20 after the last lost network connection. Therefore, in the first connection of the client 20 to the network 10, the server 12 communicates both the PRK 28 and the PUK 29 to the client 20; and in subsequent re-connections of the client 20 to the network 10, the server 12 communicates only the PRK 28 to the client 20, in some embodiments of the invention.

In some embodiments of the invention, the clients 20 may have a variety of different connections to the network 10. For example, the client 20, may be connected over a cellular connection 21 to the network fabric 18. The client 202 may be connected via a Wi-Fi connection 22 to the network 10. As yet another example, the client 20N may be connected to the network 10 via a network cable 23. Thus, the clients 20 may use different types of communication links to communicate with the network 10. Furthermore, the degree of portability of each client 20 may be different. As an example, in some embodiments of the invention, one and/or more of the clients 20 may be mobile devices, such as laptop computers, personal digital assistants (PDAs), cellular telephones, etc. Additionally, in some embodiments of the invention, one or more of the clients 20 may be more non-portable devices, such as desktop computers (as an example), in some embodiments of the invention.

Among the other features of the network 10, in accordance with some embodiments of the invention, the network establishment and key transmissions between the server 12 and a particular client 20 may be protected by such security mechanisms as a secure socket layer (SSL), an Internet Protocol security (IPsec) protocol using a tunnel mode, etc., depending on the particular embodiment of the invention.

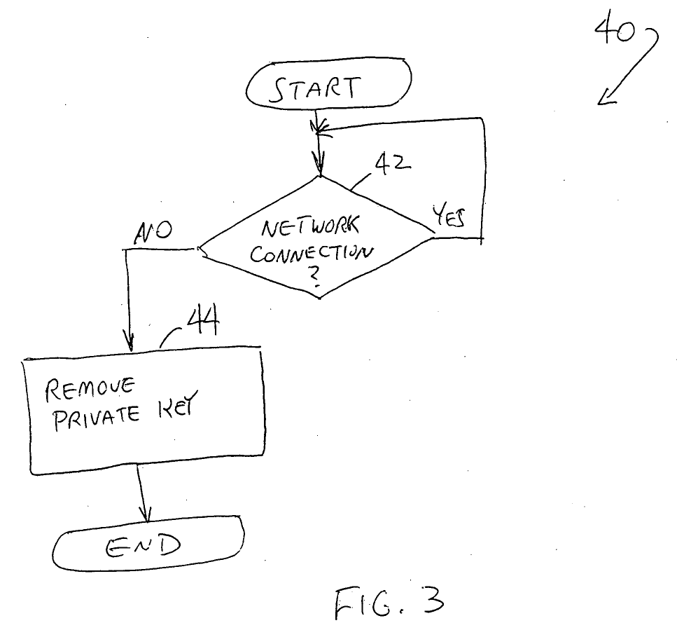

Referring to FIG. 3, therefore, in accordance with some embodiments of the invention, a particular client 20 may perform a technique 40 for purposes of securing its file access. Pursuant to the technique 40, the client 20 monitors its network connection to recognize when the network connection has been lost. This monitoring may include, for example, monitoring whether a user has logged the client 20 off of the network 10, as well as determining whether network connection has been lost due to the loss of the physical wireless or wired connection between the client 20 and the network 10. Pursuant to the technique 40, if the client 20 determines (diamond 42) that the network connection has been lost, then the client 20 removes (block 44) its access to the locally stored private key (PRK) 28. Although FIG. 3 is generally depicted as a continual polling by the client 20 to determine whether a network connection is present, it is understood that many variations are possible and are within the scope of the appended claims. For example, in some embodiments of the invention, a interrupt service routine that causes the client 20 to remove access to the locally stored PRK 28 may be triggered in response to a hardware or software interrupt that is generated in the client 20 when a network connection is lost.

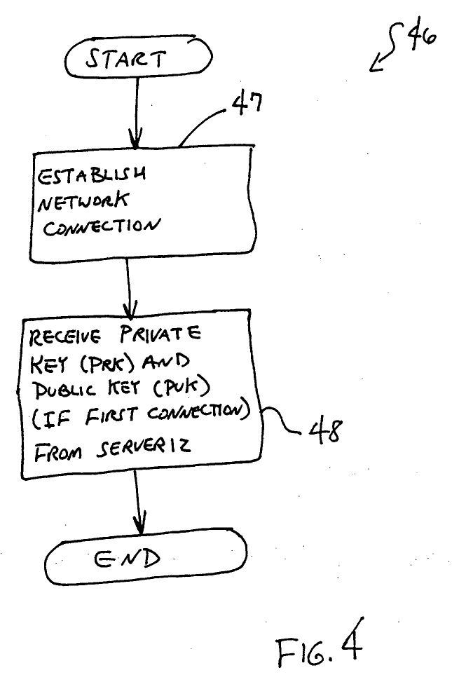

Referring to FIG. 4, in accordance with some embodiments of the invention, the client 20 may generally follow a technique 46 when logging onto the network 10. Pursuant to the technique 46, the client 20 establishes (block 47) a network connection. Subsequently, the client 20 receives (block 48) the PRK 28 from the server 12, as depicted in block 48. If this is the first time that the client 20 has logged onto the network 10, then the client 20 also receives the PUK 29 from the server 12. Other variations are possible and are within the scope of the appended claims.

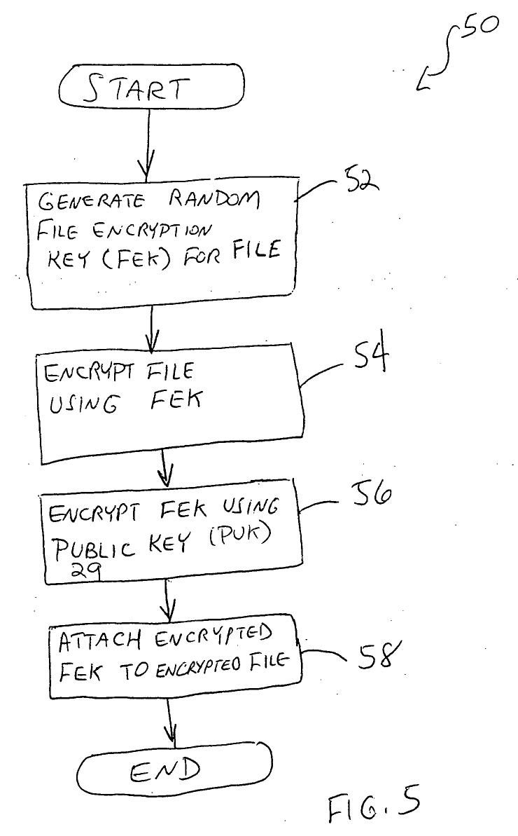

Referring to FIG. 5, in some embodiments of the invention, the client 20 may use a technique 50 for purposes of storing a protected file 24. Pursuant to the technique 50, the client 20 first generates (block 52) a random file encryption key (FEK) for the file. The FEK may be deterministic and non-predictable, in some embodiments of the invention. Furthermore, the FEK may be based on the particular file 24.

Continuing with the technique 50, the client 20 encrypts the file using the FEK, as depicted in block 54. Next, pursuant to the technique 50, the client 20 encrypts the FEK using the PUK 29, as depicted in block 56. Subsequently, the client 20 attaches (block 58) the encrypted FEK to the encrypted file.

Thus, as can be appreciated from FIG. 5, in accordance with some embodiments of the invention, the client 20 may still continue to encrypt files when the network connection has been lost, as the client 20 still has access to the PUK 29. However, due to the loss of the PRK 28, the client loses its ability to retrieve stored encrypted files.

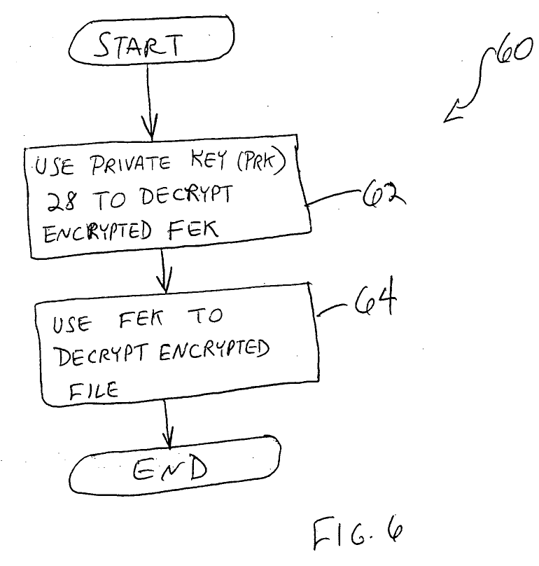

More specifically, referring to FIG. 6, in accordance with some embodiments of the invention, the client 20 uses a technique 60 to retrieve a file. Pursuant to the technique 60, the client 20 uses (block 62) the PRK 28 to decrypt the encrypted FEK that is associated with the file. If the client 20 does not have access to the PRK 28, the FEK may not be decrypted and thus, the client 20 may not access the stored file. If, however, the client 20 has access to the PRK 28, then the client 20 decrypts the FEK and then uses the FEK to decrypt the encrypted file, pursuant to block 64.

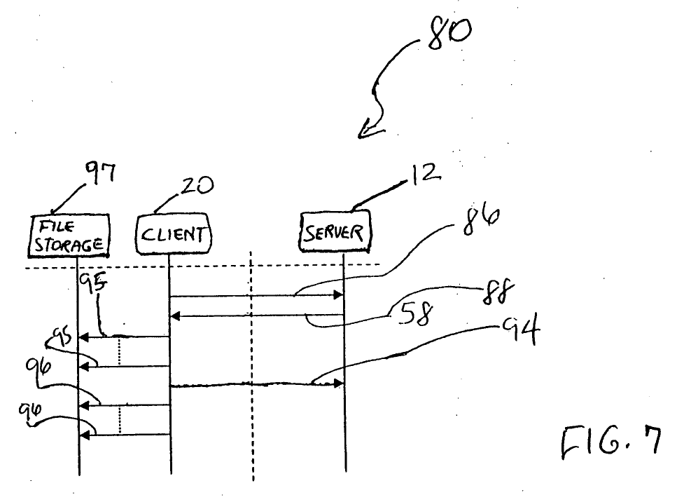

FIG. 7 depicts a signal flow diagram 80 depicting the asymmetric cryptographic security system in accordance with some embodiments of the invention. When the client 20 logs onto the network 10, the client 20 communicates (at 86) a login message to the server 12. This login message may include, for example, a user identification (ID) and a password or certificate. Assuming that the login is successful, the server 12 communicates a login successful message (at 88) to the client 20, a message that includes the PRK 28. If this is the first time that the client 20 has logged onto the network, then the login successful message also includes the PUK 29.

When possessing the PRKs 28 and PUKs 29, the client 20 is enabled to both retrieve and store the protected files 24 (FIG. 1). Thus, as depicted at 95, the client 20, while still maintaining a connection to the network 10, may communicate encrypted FEKs (encrypted with the PUK 29) with the files 24 to file storage 97 so that the files may be later decrypted by the client's PRK 28 (assuming that the network connection is maintained). FIG. 7 also depicts the scenario in which the client 20 communicates a logout message (at 94) to the server 12. Thus, the client 20 is no longer connected to the network 10. Subsequently, the client 20 may encrypt the files by communicating encrypted FEKs (at 96) with the files 24 to the file storage 97. However, as set forth above, the client 20 may not decrypt the files (due to its inability to decrypt the FEKs), as the client 20 does not have access to the PRK 28.

Other variations are possible and are within the scope of the appended claims. For example, in some embodiments of the invention, the client 20 may be permitted to retrieve files that are encrypted by the client 20 after the client's network connection is lost. Therefore, in these embodiments of the invention, the client 20 may, for example, use another pair of asymmetric keys for purposes of encrypting the FEKs after the loss of the network connection. Thus, this alternative pair of asymmetric keys may be used for purposes of encrypting and decrypting the FEKs. This allows a user to store and retrieve potentially sensitive files on the client 20 after the loss of the network connection. The user may not, however, retrieve selected files that were stored on the client 20 prior to the loss of the network connection. Therefore, many variations are possible and are within the scope of the appended claims.

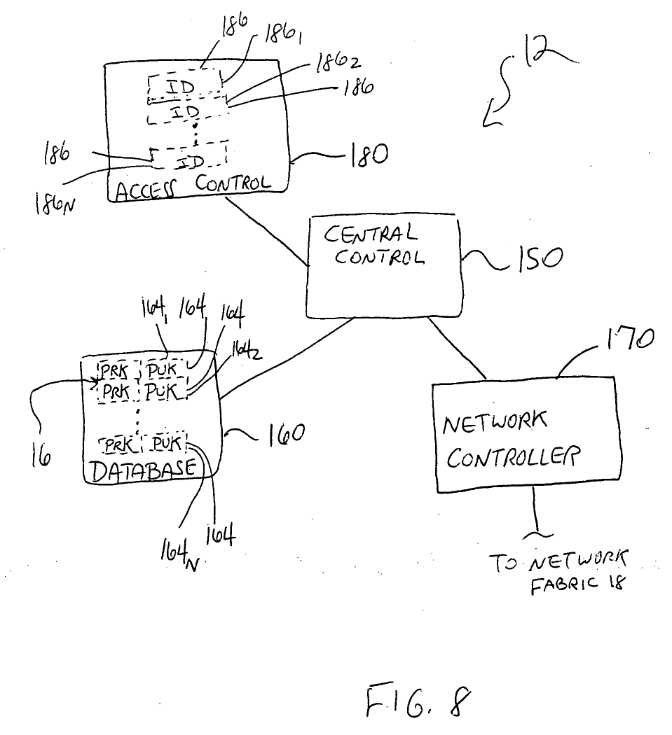

In some embodiments of the invention, the server 12 may have a software architecture that is generally depicted in FIG. 8. This architecture includes a central control module 150 that may be formed at in part by, for example, the operating system of the server 12. Furthermore, the server 12 may include a network controller module 170 for purposes of establishing the above-described communication of the keys and verification of identifications (IDs) over the network 10. In this regard, for purposes of verifying a particular ID of a client 20, the central control 150 may use an access control module 180, a module that includes a table that stores IDs 186₁, 186₂, . . . 186_{N} for the clients 20 for purposes of ensuring that an unauthorized client 20 is not attempting to retrieve the PRK 28 (for example). Although not depicted in FIG. 8, the access control module 180 may also store passwords or other security measures that are associated with the IDs for purposes of verifying the identity of each client 20.

As also depicted in FIG. 8, in some embodiments of the invention, the server 12 includes a database 160 that stores the table 16. As shown, the table 16 may include asymmetric key pairs 164 (asymmetric key pairs 164₁, 164₂, . . . 164_{N}, depicted as examples), each of which is associated with a potential client 20 of the network. Thus, for example, the asymmetric key pair 164, may be associated with the client 20, (see FIG. 1).

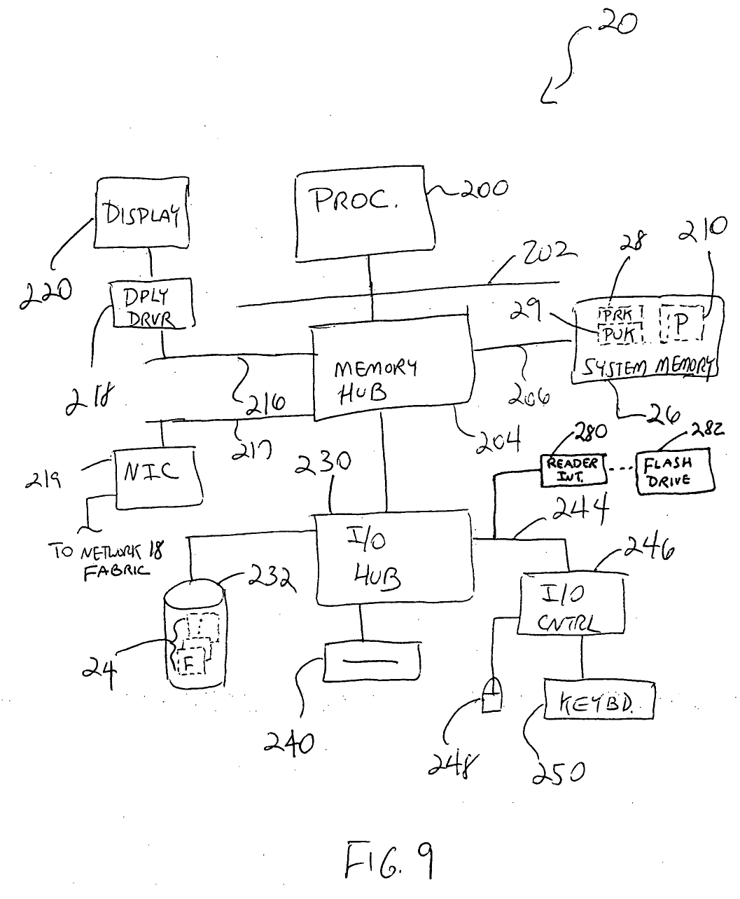

FIG. 9 depicts a schematic diagram of the client 20 in accordance with some embodiments of the invention. The client 20 includes a processor 200 (one or more microprocessors, for example) that is electrically coupled to a system bus 202. The system bus 202 allows communications between the processor 200 and a north bridge, or memory hub 204. The memory hub 204 is coupled to a memory bus 206, an Accelerated Graphics Port (AGP) bus 216 and a Peripheral Component Interconnect (PCI) bus 217. The AGP is described in detail in the Accelerated Graphics Port Interface Specification, Revision 1.0, published on Jul. 31, 1996, by Intel Corporation of Santa Clara, Calif. The PCI Specification is available from the PCI Special Interest Group, Portland, Oreg. 97214. A display driver 218 (that drives a display 220 of the client 20) may be coupled to the AGP bus 216.

As depicted in FIG. 9, the system memory 26 may be coupled to the memory bus 206. The system memory 26 may store, for example, the PRK 28 and the PUK 29, in some embodiments of the invention, when a connection is present with the network 10. It is noted that in some embodiments of the invention, upon loss of the network connection, the client 20 may erase the PRK 28, or remove a handle or pointer that points to the PRK 28. The system memory 26 may also store, for example, program instructions 210 that allow the client 20 to perform one or more of the techniques that are described above in connection with the disclosed cryptosystem.

For example, in some embodiments of the invention, the program instructions 210, when executed by the processor 200, may cause the client 20 to perform one or more of the techniques 30, 40, 46, 50 and 60 that are described above. Furthermore, when the program instructions 210 are executed by the processor 200, in some embodiments of the invention, the client 20 may perform the signaling with the server 12, as described in connection with FIG. 7.

Among the other features of the client 20, in accordance with some embodiments of the invention, the client 20 includes a network interface card (NIC) 219 that generally controls communication between the client 20 and the rest of the network 10. Additionally, the memory hub 204 may be in communication with a south bridge, or an input/output (I/O) hub 230. The I/O hub 230 establishes communication between an I/O expansion bus 244 and an I/O controller 246. The I/O controller 246, in turn, may receive input signals from such devices as a mouse 248 and a keyboard 250. A flash card reader interface 280 may be coupled to the expansion bus 244 for purposes of receiving a removable flash drive card 282 and coupling the card 282 to the client 20.

The I/O hub 230 also establishes communication between the client 20 and one or more hard disk drives 232, in some embodiments of the invention. The hard disk drive(s) 232, in turn, stores one or more of the protected files 24, in some embodiments of the invention. Furthermore, in accordance with some embodiments of the invention, one or more of the protected files 24 may be stored on a removable media, such as a CD-ROM that is inserted into a CD-ROM drive 240 that is coupled to the I/O hub 230.

It is noted that the architectures that are depicted in FIGS. 8 and 9 are merely examples of many possible embodiments of the invention. Thus, many other variations are possible and are within the scope of the appended claims.

Other embodiments of the above-described technique and system are possible and are within the scope of the appended claims. For example, in some embodiments of the invention, each protected file 24 may be stored in its entirety on the hard disk drive of the client 20. However, in accordance with other embodiments of the invention, a particular protected file 24 may be distributed among different network entities and/or different storage media. For example, a particular protected file may be stored on the network 10 and thus, may be stored on the client 20 and one or more other storage entities (flash drives, network drives, Universal Serial Bus (USB) devices, hard disk drives on other clients 20 or server 12, on removable media, etc.) of the network 10. For example, referring back to FIG. 1, in accordance with some embodiments of the invention, a particular protected file 24 may be stored on the client 20 as well as on the server 12. Alternatively, a particular protected file 24 may be stored on the client 20, on the server 12 and on one or more clients 20. Furthermore, a particular file 24 may be distributed on additional servers (not shown in FIG. 1). Additionally, a particular file 24 may be stored at least partially on a removable flash memory device or USB memory device that is inserted into the client 20 or another device that is connected to client 20 or more generally, to the network 10. Thus, many variations are possible and are within the scope of the appended claims.

The above-described distribution of storage for each protected file 24 is an additional level of security. Thus, even if the above-security measures are somehow circumvented on a client 20 for purposes of attempting to access a particular protected file 24, only a portion and not all of the entire file 24 is not present on the client 20. Thus, possession of the client 20 does not guarantee full access to a particular protected file 24.

As an example of yet another possible embodiment of the invention, the PRKs 28 and PUKs 29 may be stored in a distributed fashion. For example, the client 20 may store one of the keys on its hard drive and another one of the keys on a removable flash drive.

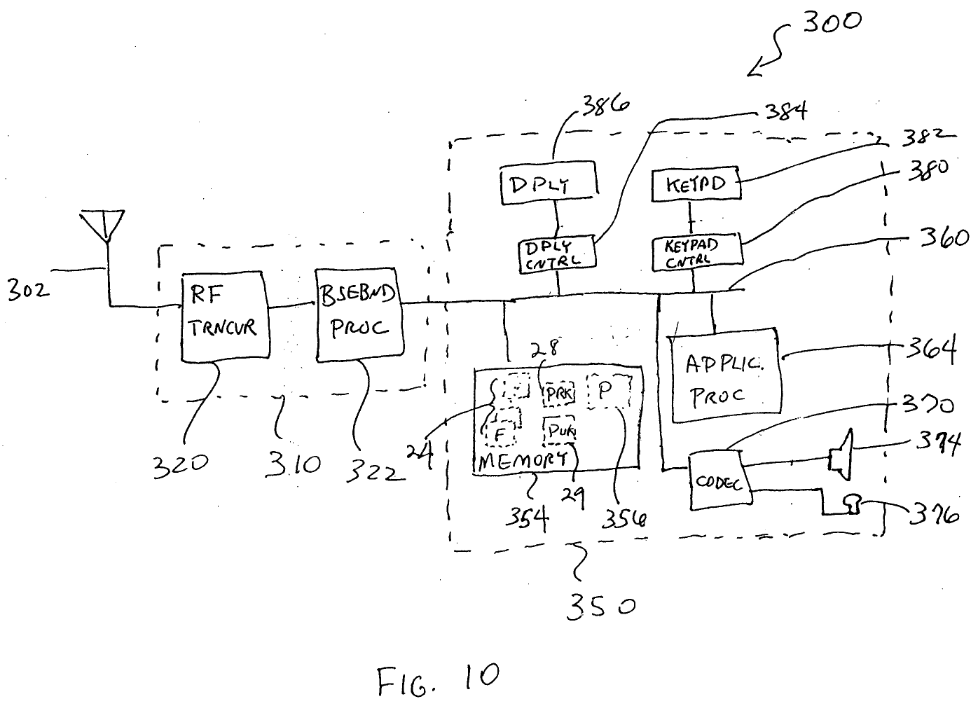

Although FIG. 9 depicts a personal computer (PC) architecture for the client 20, the client may have many different architectures, depending on the particular embodiment of the invention. For example, in accordance with some embodiments of the invention, the client 20 may be a personal digital assistant (PDA), cellular telephone, etc. FIG. 10 depicts another architecture 300 for the client 20 in accordance with some embodiments of the invention. The architecture 300 includes a baseband subsystem 310 and an application subsystem 350. The baseband subsystem 310 includes, for example, a radio frequency (RF) transceiver 320 that communicates RF signals with an antenna 302 for purposes of communicating with a wireless network. The RF transceiver 320 may be coupled to a baseband processor 322 of the baseband subsystem 310. The baseband processor 322, among its various functions, may communicate baseband signals with the RF transceiver 320 and modulate and demodulate the signals for purposes of recovering data content received from the wireless network as well as encoding data to be communicated over the wireless network.

The application subsystem 350 may include, for example, an application processor 364 that, along a memory 354, is coupled to a system bus 360. As depicted in FIG. 10, the system bus 360 may also be coupled to the baseband processor 322. The application processor 364 may, for example, generally coordinate the activities of the client 20 as well as execute certain application programs, such as a calendar program, email program, etc., depending on the particular embodiment of the invention. The memory 354, as depicted in FIG. 10, may store the PRK 28 as well as the PUK 29. Furthermore, the memory 354 may store the protected files 24 and program instructions 356 that when executed by the application processor 364 cause the client 20 to perform one or more of the techniques that are described herein.

Among its other features, the application subsystem 350 may include, for example, a codec 370 that is coupled to the system bus 360 for purposes of providing an analog signal to drive a speaker 374; and the codec 370 may, for example, receive an analog signal from a microphone 376 and convert the signal into a digital signal for further processing the application subsystem 350. The application subsystem 350 may also include a display controller 384 that drives a display 386 of the wireless device as well as a keypad controller 380 that decodes data from a keypad 382 of the wireless device. As depicted in FIG. 10, the display controller 384 and the keypad controller 380 may be coupled to the system bus 360.

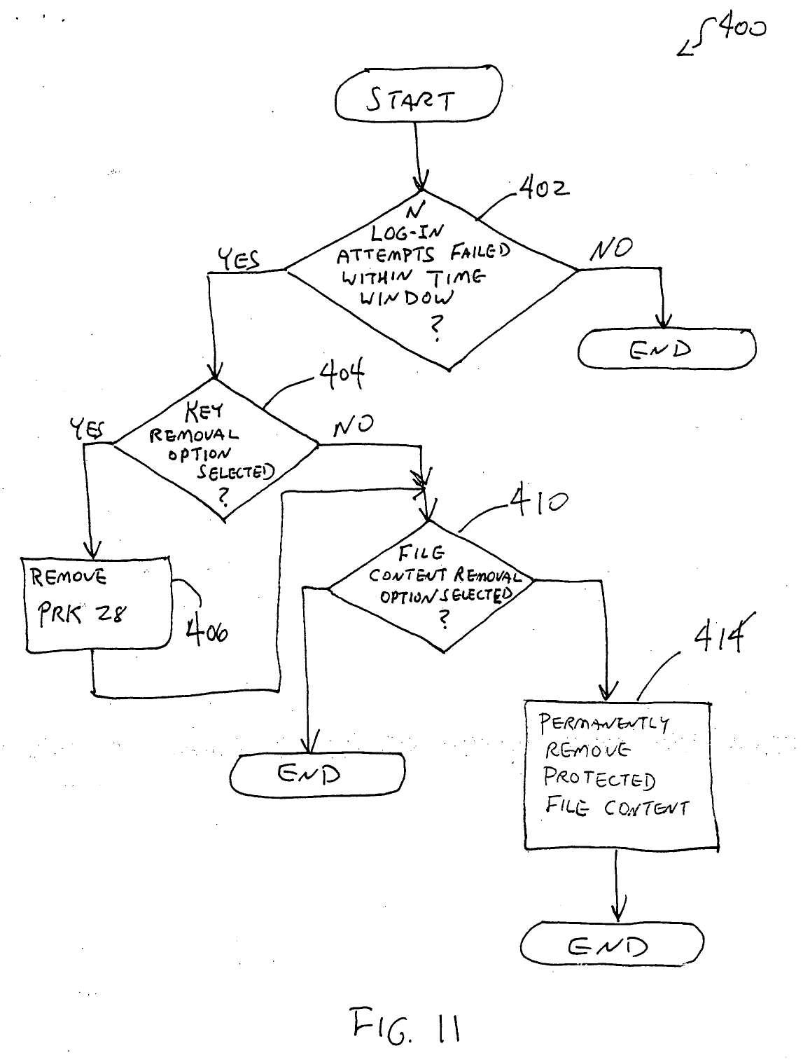

Additional security features may be provided by the client 20 in accordance with other embodiments of the invention. For example, referring to FIG. 11, in accordance with some embodiments of the invention, the client 20 may perform a technique 400 every time a log-in attempt to the network fails. The purpose of the technique 400 is to add additional security to the client 20 when conditions indicate that the client 20 may be stolen.

Pursuant to the technique 400, the client 20 determines (diamond 402) whether N log-in attempts have failed within a predetermined time window. Thus, the client may keep track of the number of failed log-in attempts, and if a certain number of log-in attempts have failed within a predetermined time interval (a moving window of time, for example), then the client 20 takes corrective action to protect the protective files 24.

For example, pursuant to the technique 400, if N log-in attempts have failed within the time window (diamond 402) then the client 20 determines (diamond 404) whether a key removal option has been selected on the client 20. This option allows the removal of the key used for decryption when the condition in diamond 402 has been satisfied. Thus, if the key removal option has been selected (diamond 404), then the client 20 removes (block 406) the keys for encryption. As depicted in FIG. 11, this key may be the PRK 28, in some embodiments of the invention. However, in other embodiments of the invention, if the key that is used for decryption of the protective files 24 is the PUK 29, then the client removes the PUK 29.

Pursuant to the technique 400, the client 20 subsequently determines (diamond 410) whether a file content removal option has been selected. Thus, the client 20 may be configured to remove one or more of the protected files 24 in response to the condition in diamond 402 being satisfied. If this is the case, then the client 20 permanently removes the protected file content, as depicted in block 414.

As yet another example of another security feature, in accordance with some embodiments of the invention, the server 12 (FIG. 1) may interact with the client 20 if a determination has been made that the client 20 is stolen. For example, the client 20 may make this assessment based on a predetermined absence from the network as well as someone notifying a system administrator that the client 20 has been stolen so that the stolen status of the client 20 is communicated to the server 12. Pursuant to the technique 450, if the server determines (diamond 452) that the client 20 has been stolen, then the server 12 communicates (block 454) a “delete command” to the client 20. The delete command is a command that when received by the client 20 instructs the client 20 to delete certain protective file content. For example, in some embodiments of the invention, when the client 20 receives the delete command, the client 20 deletes the PRK 28 and/or the protected file content (depending on the pre-selected options) pursuant to block 456. It is noted that if the PUK 29 is used for decryption, then the client 20 may delete the PUK 29.

The server 12 may communicate the delete command to the client 20 in a number of different ways. For example, in accordance with some embodiments of the invention, the client 20, after being stolen, may be able to be logged onto the network due to knowledge of the appropriate password and log-in information. However, if the server 12 has identified the client 20 as being stolen, the server 12 may then communicate the delete command that the client software recognizes and uses to delete the appropriate key and/or file content. It is possible that the user of the stolen computer 20 may not have the appropriate information to log-on to the network. In this case, in accordance with some embodiments of the invention, the server 12 communicates the delete command to the client 20 with the message that the log-in attempt to the network has failed. Thus, the client 20 does not log-on to the network but receives the delete command to cause the client 20 to delete the appropriate key and/or file content. The server 12 may use networks other than the network 10 for purposes of communicating the delete command to the client 20 in accordance with some embodiments of the invention. Thus, in accordance with some embodiments of the invention, the server 12 may communicate the delete command to the client 20 via a lower level or unsecured network, for example. Therefore, many embodiments are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
selectively preventing decryption of a file by a client based on whether a network connection exists between the client and a server.

2. The method of claim 1, wherein the act of selectively preventing comprises:
allowing the client to decrypt the file in response to the network connection; and
preventing the client from decrypting the file in response to the absence of the network connection.

3. The method of claim 1, further comprising:
permitting the client to encrypt a file regardless of whether the network connection exists.

4. The method of claim 1, wherein the act of selectively preventing comprises:
preventing the client from accessing a first key in response to the absence of the network connection.

5. The method of claim 4, wherein the first key is part of a pair of asymmetric keys.

6. The method of claim 5, further comprising:
receiving at least one of the pair of asymmetric keys from the server in the client in response to the existence of the network connection.

7. The method of claim 6, wherein the pair of asymmetric keys is one out of multiple asymmetric keys stored on the server for the client and other clients.

8. The method of claim 6, wherein the act of receiving comprises:
receiving a public key of the pair in the client.

9. The method of claim 5, further comprising:
generating a random key to encrypt the file to generate an encrypted file; and
attaching the encrypted key to the encrypted file.

10. The method of claim 9, further comprising:
in response to the resistance of the network connection, using the other of the pair of asymmetric keys to decrypt the encrypted key to reproduce the random key and use the random key to decrypt the file.

11. The method of claim 10, wherein the random key is deterministic, non-predictable and based on the file being encrypted.

12. The method of claim 5, wherein the pair of asymmetric keys is deterministic and non-predictable.

13. The method of claim 1, wherein the network connection ceases to exist when at least the client logs off of the network or loses physical network access to the server.

14. The method of claim 1, further comprising:
preventing decryption of the file by the client based on whether a predetermined number of log-in attempts between the client and the server has failed within a predetermined window of time.

15. The method of claim 14, further comprising:
removing a key in response to the predetermined number of log-in attempts failing within the predetermined window of time.

16. The method of claim 14, further comprising:
removing at least part of the file in response to the predetermined number of log-in attempts failing within the predetermined window of time.

17. A system comprising:
a server; and
a plurality of clients,
wherein at least one of the clients selectively prevents decryption of a file by the client based on whether a network connection exists between the client and the server.

18. The system of claim 17, wherein said at least one client allows the client to decrypt the file in response to the network connection and prevents the client from decrypting the file in response to the absence of the network connection.

19. The system of claim 17, wherein said at least one client encrypts the file regardless of whether the network connection exists.

20. The system of claim 17, wherein said at least one client is prevented from accessing a first key in response to the absence of the network connection.

21. The system of claim 20, wherein the first key is part of a pair of asymmetric keys.

22. The system of claim 21, wherein said at least one client generates a random key to encrypt the file to generate an encrypted file, uses one of the pair of asymmetric keys to encrypt the random key to produce an encrypted key, and attaches the encrypted key to the encrypted file.

23. The system of claim 17, wherein communications between the server and the clients use at least one of a secure sockets layer and an internet security protocol operating in a tunnel mode.

24. The system of claim 17, wherein the file is distributed on the client and at least one other entity separate from the client.

25. The system of claim 17, wherein the server comprises an access control module to authenticate a client by at least checking its identification against a value in a database.

26. The system of claim 17, wherein said at least one client is adapted to communicate at least its user identification to the server to be verified for the server for purposes of being enabled to decrypt the file.

27. An article comprising a computer readable storage medium storing instructions that when executed by a computer cause the computer to:
selectively prevent decryption of a file by a client based on whether a network connection exists between the client and a server.

28. The article of claim 27, the storage medium storing instructions to cause the computer to allow the client to decrypt the file in response to the network connection and prevent the client decrypting the file in response to the absence of the network connection.

29. The article of claim 27, the storage medium storing instructions to cause the client to encrypt a file regardless of whether the network connection exists.

30. The article of claim 27, the storage medium storing instructions that when executed prevent the client from accessing a first key in response to the absence of the network connection.

31. The article of claim 27, wherein the first key is part of a pair of asymmetric keys.

32. The article of claim 27, the storage medium storing instructions that when executed cause the client to generate a random key to encrypt the file to generate an encrypted file, use one of the pair of asymmetric keys to encrypt the random key to produce an encrypted random key, and attach the encrypted random key to the encrypted file.

33. The article of claim 32, the storage medium storing instructions that when executed cause the client to, in response to the existence of the network connection, use the other of the pair of asymmetric keys to decrypt the encrypted key to reproduce the random key to decrypt the file.

34. A method comprising:
receiving an indication in a server that a client associated with the server has been stolen; and
in response to the indication, communicating a command from the server to the client instructing the client to take protective action to protect a file stored on the client.

35. The method of claim 34, wherein the corrective action comprises deleting at least part of the file.

36. The method of claim 34, wherein the corrective action comprises removing a key used to decrypt the file by the client.
